(19) United States
(12) Patent Application Publication
(10) Pub. No.: US 2023/0084211 A1
(43) Pub. Date: Mar. 16, 2023

(54) MALLEABLE AND DEGRADABLE BENZOXAZINES

(71) Applicant: KANEKA CORPORATION, Osaka (JP)

(72) Inventors: Samuel Kyran, Pasadena, TX (US); Young Hoon Lim, Pasadena, TX (US)

(73) Assignee: KANEKA CORPORATION, Osaka (JP)

(21) Appl. No.: 17/891,905

(22) Filed: Aug. 19, 2022

Related U.S. Application Data
(60) Provisional application No. 63/234,912, filed on Aug. 19, 2021.

(51) Int. Cl. C08G 12/08; C08K 7/02; C08J 11/16

(52) U.S. Cl. CPC C08G 12/08; C08K 7/02; C08J 11/16; C08J 2361/22

(57) ABSTRACT

A degradable resin composition comprising at least one benzoxazine group in a backbone or as an endcap and at least one cleavable covalent bond is provided. Also provided is a thermoset composition comprising a cured benzoxazine-based resin composition including at least one imine group. A degradable resin composition comprising at least one benzoxazine group in a backbone or an endcap, at least one acetal group, and at least one acrylate group is also provided. A method of recycling a resin composition includes providing a cured polymer resin composite which comprises a cured benzoxazine-based resin composition including at least one cleavable covalent bond, and fibers. The method then includes exposing the cured polymer resin composite to an acid, thereby cleaving the at least one cleavable covalent bond to produce a degraded polymer resin, and removing the fibers from the degraded polymer resin.

### BACKGROUND

Thermoset resins (“thermosets”) and thermoplastic resins (“thermoplastics”) are distinct classes of polymers, distinguished from each other based on their behavior in the presence of heat. Specifically, thermoplastics such as polyethylene (PE), polycarbonate (PC), and polyetheretherketone (PEEK) become pliable or moldable upon application of heat (solidifying upon cooling), whereas thermosets such as epoxy, benzoxazine, and bismaleimide are irreversibly hardened upon curing, and cannot be melted or reshaped on heating. Thus, thermoplastic materials have melting temperatures (a melting point) where they start to flow, while thermoset products that have been cured can withstand higher temperatures without loss of their structural integrity.

Fiber reinforced polymer composites made from thermosets and/or thermoplastics are increasingly used in applications such as aerospace, automotive, wind power, civil engineering, and high-end sports goods. However, a large percentage of carbon fiber used in such composites ends up as waste in landfills. While thermoplastic composites have the capability to be recycled and reprocessed, thermoset composites with highly crosslinked matrices pose a challenge for recyclability.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a degradable resin composition, comprising at least one benzoxazine group in a backbone or as an endcap and at least one cleavable covalent bond.

In another aspect, embodiments disclosed herein relate to thermoset composition, comprising a cured benzoxazine-based resin composition including at least one imine group.

In yet another aspect, embodiments disclosed herein relate to a degradable resin composition, comprising at least one benzoxazine group in a backbone or an endcap, at least one acetal group, and at least one acrylate group.

In another aspect, embodiments disclosed herein relate to a method of recycling a resin composition. The method comprises providing a cured polymer resin composite. The cured polymer resin composite comprises a cured benzoxazine-based resin composition including at least one cleavable covalent bond, and fibers. The method also comprises exposing the cured polymer resin composite to an acid, thereby cleaving the at least one cleavable covalent bond to produce a degraded polymer resin, and removing the fibers from the degraded polymer resin.

Other aspects and advantages of the claimed subject matter will be apparent from the following description and the appended claims.

### BRIEF DESCRIPTION OF DRAWINGS

FIG. 1 is schematic of a number of reaction schemes to synthesize imino-benzoxazines in accordance with one or more embodiments.

FIG. 2 is a reaction scheme to form a benzoxazine resin in accordance with one or more embodiments.

FIG. 3 is a reaction scheme showing the cleaving of imino bonds in the presence of acid in accordance with one or more embodiments.

FIG. 4 is a scheme showing the reprocessing of a thermoset in accordance with one or more embodiments.

### DETAILED DESCRIPTION

Embodiments of the present disclosure generally relate to recyclable thermosets, specifically cured benzoxazine-based resins. The thermosets include degradable covalent bonds that may be cleaved upon exposure to acid. Therefore, the disclosed thermosets may be degraded into thermoplastic oligomers upon exposure to acid. The thermoplastic oligomers may be reused to form polymers. Additionally, disclosed thermosets may be reprocessed via melt processing methods for reuse. Thus, the present disclosure provides recyclable and reprocessable thermosets made from benzoxazine-based resins.

One or more embodiments of the present disclosure relate to a degradable thermoset made from a cross-linkable (i.e. curable) benzoxazine-based resin that is a thermoset once cured. The cross-linkable benzoxazine-based resin includes at least one benzoxazine (BZ) group therein (along the backbone or in an end-cap) or is formed from a BZ monomer (ring-opening during the formation of the benzoxazine-based resin) or a combination thereof. The BZ group in the benzoxazine-based resin or BZ monomer may have a structure represented by formula (I):

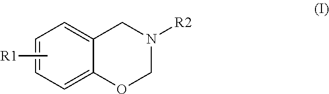

R1 may represent one or more of a hydrogen atom, a hydrocarbon group, a substituted hydrocarbon group, and a functional group. The BZ groups of one or more embodiments may include one or more substituents represented by R1. As used throughout this description, the term “hydrocarbon group” may refer to branched, straight chain, and/or ring-containing hydrocarbon groups, which may be saturated or unsaturated. The hydrocarbon groups may be primary, secondary, and/or tertiary hydrocarbons. As used throughout this description, the term “substituted hydrocarbon group” may refer to a hydrocarbon group (as defined above) where at least one hydrogen atom is replaced with a non-hydrogen group that results in a stable compound. Such substituents may be groups selected from, but are not limited to, halo, hydroxyl, alkoxy, oxo, alkanoyl, aryloxy, alkanoyloxy, amino, alkylamino, arylamino, arylalkylamino, disubstituted amines, alkanylamino, aroylamino, aralkanoylamino, substituted alkanoylamino, substituted arylamino, substituted aralkanoylamino, thiol, alkylthio, arylthio, arylalkylthio, alkylthiono, arylthiono, aryalkylthiono, alkylsulfonyl, arylsulfonyl, arylalkylsulfonyl, sulfonamide, substituted sulfonamide, nitro, cyano, carboxy, carbamyl, alkoxycarbonyl, aryl, substituted aryl, guanidine, vinyl, acetylene, acrylate, cyanate, epoxide, and heterocyclyl groups, and mixtures thereof. The functional groups may be groups selected from, but are not limited to, halo, hydroxyl, alkoxy, oxo, amino, amido, thiol, alkylthio, sulfonyl, alkylsulfonyl, sulfonamide, substituted sulfonamide, nitro, cyano, carboxy, carbamyl, alkoxycarbonyl vinyl, acetylene, acrylate, cyanate, epoxide groups, and mixtures thereof.

R2 is not particularly limited and may represent any of the groups mentioned with regard to R1. However, in particular embodiments, R2 may be a BZ-containing moiety. When R2 is a BZ-containing moiety, the BZ-based resin may include bis-BZ units. The bis-BZ units may have a structure represented by formula (II):

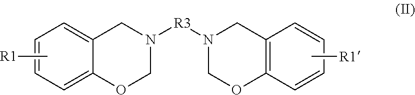

R1 represents a group as discussed above with regard to formula (I). R1′ may be a group that is the same as, or different from, R1. R3 may represent a hydrocarbon group or a substituted hydrocarbon group. In particular embodiments, R3 may represent or include at least one aromatic group selected from, but not limited to, benzene, bibenzyl, diphenylmethane, naphthalene, anthracene, diphenyl ether, diphenyl sulfone ether, bis(phenoxy) benzene, stilbene, phenanthrene, fluorine, and substituted variants thereof. Embodiments that include more than one of such aromatic groups may include a linker such as an alkyl linker therebetween. In one or more embodiments, R3 may represent a group having a molecular weight in a range of about 1 to 100,000 Da, or 1 to 10,000 Da, or 1 to 1,000 Da.

In some embodiments, the BZ-based resin may include BZ-containing units may have a structure represented by formula (III):

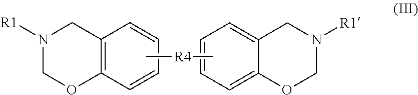

R1 represents a group as discussed above with regard to formula (I). R1′ may be a group that is the same as, or different from, R1. R4 may be selected from, but is not limited to, a hydrocarbon, ether, secondary-amino, amido, thioether, sulfonyl, sulfonamide, carbonyl, carbamyl, fluorenyl, alkoxycarbonyl, and mixtures thereof. In one or more embodiments, R4 may represent a group having a molecular weight of a range of about 1 to 100,000 Da, or 1 to 10,000 Da, or 1 to 1,000 Da. In one or more embodiments, one or more BZ-containing units represented by formula (II) and (III) may be used in combination.

The BZ groups disclosed herein may be cross-linkable (i.e., curable) groups that can be reacted with each other to form a polymerized structure and subsequently cross-linked by external stimuli selected from heat, ultraviolet irradiation, microwave irradiation, moisture, and so on. Examples of such benzoxazine-based resins include those described in PCT/IB2021/020016 and PCT/IB2021/020018, which are hereby incorporated by reference in their entirety. In one or more embodiments, the cross-linkable groups may include BZ groups in the backbone or included as end-caps.

It is also envisioned that other cross-linkable groups may be used in combination with the BZ group and/or BZ monomer. Such cross-linkable groups are capable of reacting by external stimuli and may be included in disclosed benzoxazine-based resins to be cross-linked together. For example, the cross-linkable groups activated by heat may include, but are not limited to, acrylate, epoxy, nitrile, bismaleimide, citraconic imide, and other unsaturated hydrocarbon groups such as nadic imide, phenylethynyl, phenylethynyl imide, and so on. The cross-linkable groups activated by ultraviolet radiation may include, but are not limited to, acrylic, methacrylic, cinnamic, allyl azide, and other unsaturated hydrocarbon groups. In some embodiments, these cross-linkable groups can be used independently. In other embodiments, two or more cross-linkable groups can be used together. Also, for example, the cross-linkable groups activated by microwave irradiation may include, but are not limited to, epoxy and other unsaturated hydrocarbon groups. These cross-linkable groups may be used independently or together. The cross-linkable groups activated by moisture absorption may include, but are not limited to, cyanoacrylate, isocyanate, and alkoxysilanes. These cross-linkable groups may be used with catalysts for accelerating the cure reaction.

BZ-based resins disclosed herein also include a degradable covalent bond, meaning the bond may be selectively broken (i.e., cleaved). The degradable covalent bond is generally included in a portion of a polymer backbone that also includes at least one BZ-group as previously described. In one or more embodiments, the degradable covalent may be an imine (C═N), an acetal, an ester, a disulfide, and combinations thereof. In particular, one or more embodiments may incorporate the imine and/or acetal into the BZ group or BZ monomer used to form the benzoxazine-based resin.

An imine (C═N) functional group (present in the resin as a degradable covalent bond) may be prepared by reacting a primary amine with a carbonyl (C═O) functional group, such as an aldehyde or a ketone. This condensation reaction proceeds favorably in polar solvents and water is the only byproduct. On the other hand, to form a BZ group, a typical reaction may include reacting a primary amine with a phenol and paraformaldehyde (PF). Such reactions proceed more favorably in non-polar solvents. An imino-BZ compound can thus be prepared if the phenol is replaced with phenolic-aldehydes (also known as hydroxy benzaldehydes). Alternatively, amino-phenol and dialdehyde reactants may be employed.

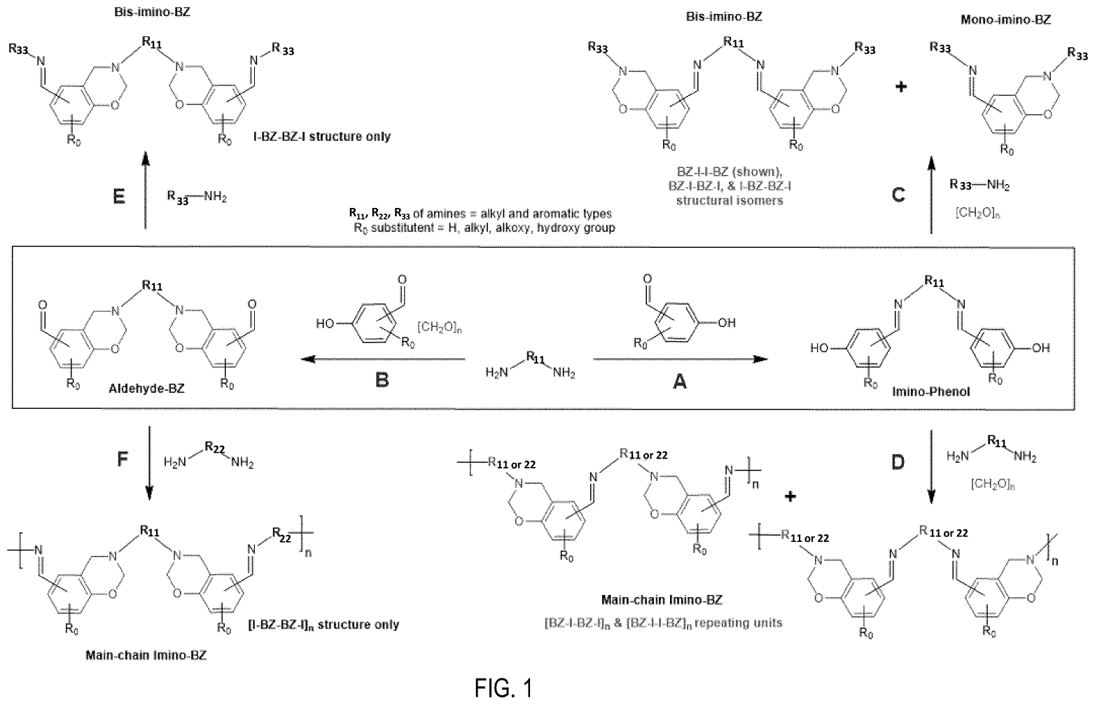

A diagram showing several possible reaction schemes for synthesizing imino-BZ compounds is shown in FIG. 1. In the reaction scheme labelled A in FIG. 1, an imino-phenol is first formed as an intermediate. The imino phenol may then be reacted with a monoamine or a diamine. In the case of a reaction with a monoamine (reaction scheme C) mono- and/or bis-BZ molecules may be formed via transimination. In the case of a reaction with a diamine (reaction scheme D), polymers including BZ groups and imine bonds may be formed. Such imino-BZ molecules and polymers may be included in the crosslinkable BZ-based resins of one or more embodiments.

In the reaction scheme labelled B in FIG. 1, an aldehyde-BZ is first formed as an intermediate. The aldehyde-BZ is then reacted with a monoamine or a diamine. In the case of a reaction with a monoamine (reaction scheme E), bis-BZ molecules may be formed. In the case of a reaction with a diamine (reaction scheme F), polymers including BZ groups and imine bonds may be formed. Such BZ- and imine-containing molecules and polymers may be included in the cross-linkable BZ-based resins of one or more embodiments.

As noted above, in the reaction schemes shown in FIG. 1, monoamines or diamines may be employed as reactants. In the case in which diamines are used, examples of suitable diamine compounds include those having a carbon number of 6 to 27 such as bis[4-(3-aminophenoxy)phenyl]sulfone (BAPS-m), bis[4-(4-aminophenoxy)phenyl]sulfone (BAPS-p), 1,4-diaminobenzene (PPD), 1,3-diaminobenzene (MPD), 2,4-diaminotoluene (2,4-TDA), 4,4′-diaminodiphenylmethane (MDA), 4,4′-diaminodiphenylether (ODA), 3,4′-diaminodiphenylether (DPE), 3,3′-dimethyl-4,4′-diaminobiphenyl (TB), 2,2′-dimethyl-4,4′-diaminobiphenyl (m-TB), 2,2′-bis(trifluoromethyl)-4,4′-diaminobiphenyl (TFMB), 3,7-diamino-dimethyldibenzothiophen-5,5-dioxide (TSN), 4,4′-diaminobenzophenone, 3,3′-diaminobenzophenone, 4,4′-bis(4-aminophenyl) sulfide (ASD), 4,4′-diaminodiphenyl sulfone (ASN), 4,4′-diaminobenzanilide (DABA), 1,n-bis(4-aminophenoxy)alkane (n=3, 4 or 5, DAnMG), 1,3-bis(4-aminophenoxy)-2,2-dimethylpropane (DANPG), 1,2-bis[2-(4-aminophenoxy)ethoxy]ethane (DA3EG), 1,5-bis(4-aminophenoxy) pentane (DASMG), 1,3-bis(4-aminophenoxy) propane (DA3MG), 9,9-bis(4-aminophenyl)fluorene (FDA), 5(6)-amino-1-(4-aminomethyl)-1,3,3-trimethylindan, 1,4-bis(4-aminophenoxy)benzene (TPE-Q or APB-144), 1,3-bis(4-aminophenoxy)benzene (TPE-R or APB-134 or RODA), 1,3-bis(3-aminophenoxy)benzene (APB or APB-133)), 4,4′-bis(4-aminophenoxy) biphenyl (BAPB), 4,4′-bis(3-aminophenoxy)biphenyl, 2,2-bis[4-(4-aminophenoxy)phenyl]propane (BAPP), 2,2-bis[4-(4-aminophenoxy)phenyl]hexafluoropropane (HFBAPP), 3,3 ′-dicarboxy-4,4′-diaminodiphenylmethane (MBAA), 4,6-dihydroxy-1,3-phenylenediamine (known as 4,6-diaminoresorcin), 3,3′-dihydroxy-4,4′-diaminobiphenyl (HAB) and 3,3′,4,4′-tetraminobiphenyl (TAB); aliphatic or alicyclic diamine compounds having a carbon number of 6 to 24 such as 1,6-hexamethylenediamine (HMD), 1,8-octamethylenediamine (OMDA), 1,9-nonamethylene diamine, 1,12-dodecamethylene diamine (DMDA), 1-amino-3-aminomethyl-3,5,5-trimethylcyclohexane, 4,4′-dicyclohexylmethanediamine and cyclohexanediamine; and silicone based diamine compounds such as 1,3-bis(3-aminopropyl)-1,1,3,3-tetramethyldisiloxane.

In one or more particular embodiments, the degradable resin composition may be made by reacting a first diamine with a phenolic aldehyde to produce an aldehyde-containing intermediate. The aldehyde-containing intermediate may be an aldehyde-BZ as described above. Then, the aldehyde-containing intermediate is reacted with a second diamine to form the degradable resin composition. The first diamine and the second diamine may be the same or different and are as described above. In particular embodiments, the first diamine and the second diamine are both 2,2-Bis[4-(4-aminophenoxy) phenyl]propane.

When a phenolic aldehyde is used to produce an aldehyde-containing intermediate, the phenolic aldehyde may be 2-hydroxybenzaldehyde, 3-hydroxybenzaldehyde, 4-hydroxybenzaldehyde, 4-hydroxy-3-methoxybenzaldehyde (vanillin), 3-hydroxy methoxybenzaldehyde, 2-hydroxy-4-methoxybenzaldehyde, 2-hydroxy methoxybenzaldehyde, 2-hydroxy-5-methylbenzaldehyde, 3-ethoxy-4-hydroxybenzaldehyde, 2,4-dihydroxybenzaldehyde, 2,3-dihydroxybenzaldehyde, or 3,4-dihydroxybenzaldehyde.

As shown in FIG. 1, in one or more particular embodiments, the resin has a structure as shown in Formula (IV) (and also in reaction scheme F).

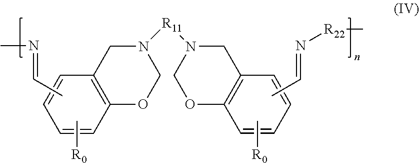

where R₁₁ and R₂₂ are independently an alkyl group, an aryl group, and alkylaryl group, a substituted alkyl group, a substituted aryl group, or a substituted alkylaryl group, R₀ a hydrogen, alkyl, alkoxy, or hydroxy group, and n is an integer ranging from 1 to 100. For example, in one or more embodiments, n may be an integer having a lower limit of any one of 1, 2, 3, 5, 10, 15 and 20 and an upper limit of any one of 20, 25, 30, 50 75, 80, 90 and 100, where any lower limit may be paired with any mathematically compatible upper limit. The value of n may be selected to give rise to a balance of characteristics of the resin, including moldability of the resin, and good thermal and mechanical properties of the cured thermoset. In particular embodiments, Ru₁₁ may represent or include at least one aromatic group selected from, but not limited to, benzene, bibenzyl, diphenylmethane, naphthalene, anthracene, diphenyl ether, diphenyl sulfone ether, bis(phenoxy) benzene, stilbene, phenanthrene, fluorine, and substituted variants thereof.

The R₁₁ group in Formula (IV) is derived from the first diamine, which is used to prepare the aldehyde-containing intermediate and the R₂₂ group is derived from the second diamine, which is reacted with the aldehyde-containing intermediate to produce the structure of Formula (IV). The R₀ group is derived from the phenolic aldehyde, which is used to prepare the aldehyde-containing intermediate.

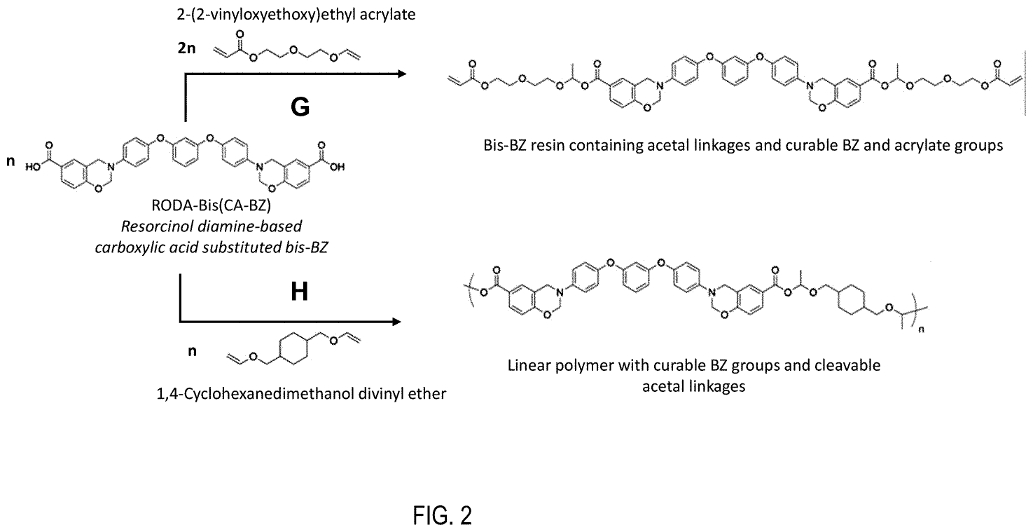

A method of synthesizing a BZ- and acetal-containing resin in accordance with one or more embodiments is shown in FIG. 2. In FIG. 2, in the reaction scheme labelled G, a bis-BZ and an acrylate-containing compound (i.e., 2-(2-vinyloxyethoxy)ethyl acrylate) are conjugated via an acetalization reaction. The carboxylic acid of the bis-BZ and the vinyl ether moiety of the 2-(2-vinyloxyethoxy)ethyl acrylate may be acetylated in tetrahydrofuran in the absence of a catalyst. The resultant BZ- and acrylate-containing resin includes curable BZ and acrylate groups, and cleavable acetal groups. In the case of a reaction with a divinyl ether (reaction scheme H), a polymer including BZ groups and acetal groups may be formed.

Upon formation of a benzoxazine-based resin, the BZ group and/or other cross-linkable groups may be cured (cross-linked) in a variety of manners, including but not limited to by external stimuli selected from heat, ultraviolet irradiation, microwave irradiation, moisture, and so on, including for example, cure cycle, solution casting, hot-melt pressing, etc. The cure mechanism may be selected depending on the type of article and the way in which the benzoxazine-based resin is to be used, for example, as an impregnator (such as in composite fibers to form a pre-preg), composite, adhesive, coating, etc. For example, prior to curing, the BZ resin may be raised above a pre-cure Tg but below the cure temperature so that the BZ resin may be melt-processed into its desired form and then cured to crosslink and solidify the resin.

In one or more embodiments, the benzoxazine-based resin may be formulated with additives, tougheners made from thermoplastic resins, thermosetting resins, inorganic salts, organic compound, and so on. The formulation can be performed by a powder dry mixing, melt mixing, or mixing in solution. The shape of both the additives and the tougheners may involve a particle that may include, but is not limited to, a plate or a fiber, for example. One or more additives, tougheners, and fibers may be formulated together with the benzoxazine-based resin. In another example, one or more thermosetting resins can be formulated together with the benzoxazine-based resin and thermally co-cured. Such thermosetting resin may include, but is not limited to, epoxy, bismaleimide, cyanate ester, and so on. In one or more embodiments, inorganic salts, organic compounds, and a combination thereof may be used with the benzoxazine-based resin to lower the curing temperature. For example, the organic compound involves a functional group including, but not limited to, an amino group, imidazole group, carboxylic group, hydroxy group, sulfonyl group, and so on.

The shape of the benzoxazine-based resin may involve a powder that includes, but is not limited to, a film, chunk, fiber, and so on. The film, chunk, and/or fiber can be made by thermal treatment of the powder of the benzoxazine-based resin or its solution using a press molding or casting method. The molded articles can be also remolded to change the shape by a casting or press molding method when using partially cured benzoxazine-based resins.

The benzoxazine-based resin articles can be partially or fully cured with other benzoxazine-based resin articles together at both of the surfaces. The benzoxazine-based resin articles can be partially or fully cured with other articles such as thermoplastic resins, thermosetting resins, glass plates, fibers, or metals, at either or both of the surfaces of the resulting articles.

In one or more particular embodiments, the benzoxazine-based resins of the present disclosure may be used to form prepregs, composite materials, adhesives, coatings, etc. Specifically, the benzoxazine-based resin composition as discussed above may be combined with reinforcement fibers to form a composite material or structure, including pre-pregs formed by impregnating a layer or weave of fibers. A resin film may be formed from the curable resin composition by, for example, compression molding, extrusion, melt-casting, or belt-casting, followed by laminating such film to one or both opposing surfaces of another layer, including for example a layer of reinforcement fibers in the form of, for example, a non-woven mat of relatively short fibers, a woven fabric of continuous fibers, or a layer of unilaterally aligned fibers (i.e., fibers aligned along the same direction), at temperature and pressure sufficient to cause the resin film to flow and impregnate the fibers. Alternatively, a prepreg may be fabricated by providing the resin composition in liquid form, passing the layer of fibers through the liquid resin composition to infuse the layer of fibers with the heat curable composition, and removing the excess resin from the infused fibrous layer.

To fabricate a composite part from prepregs, plies of impregnated reinforcing fibers are laid up on a tool and laminated together by heat and pressure, for example by autoclave, vacuum, compression molding, or heated rollers, at the curing temperature range of the resin composition and at a pressure in particular in excess of 1 bar, preferably in the range of 1 to 10 bar.

Thus, in accordance with embodiments of the present disclosure, the benzoxazine-based resin may be melt-processed to apply the benzoxazine-based resin, such as to form a pre-preg, composite, coating, adhesive layer, etc. During or following such application, once the benzoxazine-based resin is desired to set, the benzoxazine-based resin may be cured to trigger ring-opening or crosslinking within the BZ resin, thereby triggering thermosetting properties.

In the formation of a coating or adhesive layer, application of the formulated coating can be made via conventional methods such as spraying, roller coating, dip coating, etc., and then the coated system may be cured by baking.

As noted previously, once a thermoset has been formed from the benzoxazine-based resin, the thermoset may be degradable due to the inclusion of cleavable covalent bonds. Thus, thermosets in accordance with one or more embodiments may be depolymerized into oligomers or monomers via the cleavable bonds. The resultant oligomers and monomers may be recycled for further use.

Thus, one or more embodiments of the present disclosure relate to a method of recycling a resin composition. Methods disclosed herein include degrading the previously described benzoxazine-based resins. In one or more embodiments, the degradation, or cleaving of the cleavable covalent bonds, may be triggered upon exposure to an acidic medium. The acidic medium may include any suitable acid in a solvent such as water and/or THF. In one or more embodiments, the acid may be acetic acid, hydrochloric acid, nitric acid, or sulfuric acid. The acidic medium may include a concentration of acid appropriate for degrading the thermoset. Once exposed to the acidic medium for a suitable period of time, the benzoxazine-based resin may be degraded into monomers and oligomers suitable for reuse to form new resins.

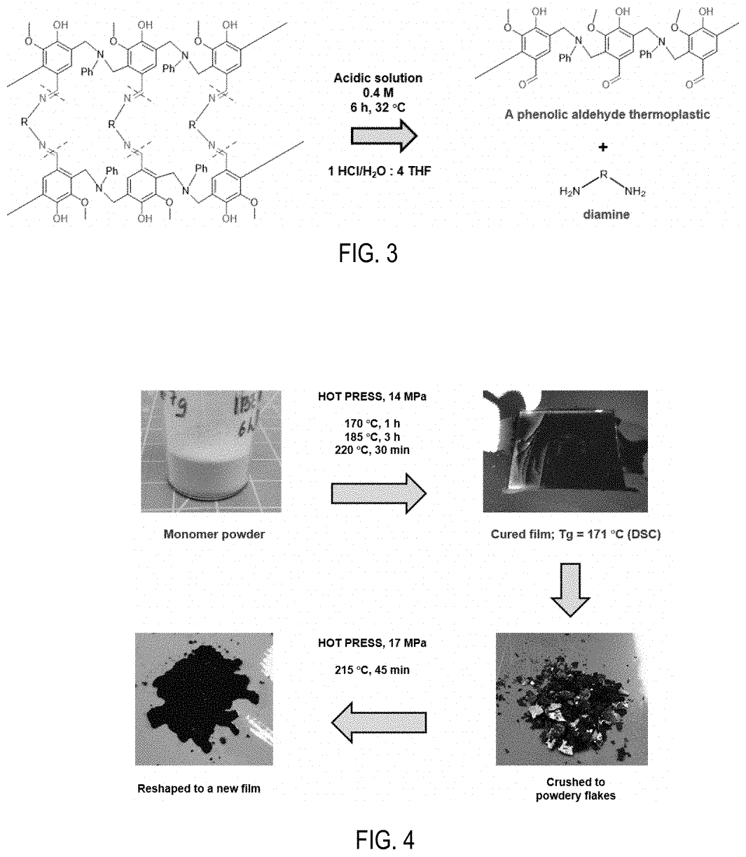

An exemplary schematic showing the degradation of an imino-BZ thermoset is shown in FIG. 3. In the embodiment shown in FIG. 3, imino covalent bonds are cleaved upon exposure to a 0.4 molar solution of HCl in a water and THF solvent mixture. The imino-BZ thermoset is degraded into diamines and phenolic aldehyde thermoplastic oligomers. As described previously, such oligomers and diamines may be reacted again to build a benzoxazine-based resin, thus providing a readily recyclable material.

In one or more embodiments, the thermoset may be a composite material that includes fibers. In such embodiments, upon degradation of the benzoxazine-based resin when exposed to acid, the fibers may be separated from the oligomers and monomers. As such, fiber components of composite materials may also be recycled for reuse. As used herein, the term “recycle” means to process a waste material into a reusable material. For example, once a composite material including a thermoset and fibers as described herein has reached the end of its usability, it can be recycled (i.e., processed via degradation) in order to separate the fibers from the thermoset in order to reuse the fibers, and also potentially oligomers and monomers derived from the thermoset.

In addition to being recyclable, thermosets disclosed herein may also be reprocessable. As used herein, “reprocessable” means that the thermoset may be remolded into another form. For example, a crosslinked thermoset made from an imino-BZ resin may be crushed into a powder form that can be melt processed into a newly cured thermoset. The reprocessability of the thermosets is due to a vitrimeric melt behavior provided by the imino bonds, whereby, the polymer chains can undergo network exchange via an associative bond exchange mechanism (i.e., maintaining a fixed crosslink density and network integrity via a transition intermediate) at elevated temperatures. Vitrimeric materials thus exhibit not only a conventional glass transition temperature (Tg) that defines the segmental rotation of polymer chains (change from glassy to rubbery state), but also a topology freezing transition temperature (Tv) that defines the rapid network exchange reactions which allow material flow by stress relaxation.

### Examples

The following examples are merely illustrative and should not be interpreted as limiting the scope of the present disclosure.

Materials

4,4-Oxydianiline (ODA), and 2,2-Bis[4-(4-aminophenoxy) phenyl]propane (BAPP) were obtained from Seika. 4-Hydroxybenzaldehyde (4-HB), Vanillin (4-Hydroxy-3-methoxy benzaldehyde), tetrahydrofuran (THF), dioxane and hexanes were obtained from Beantown Chemical. Paraformaldehyde (PF) and ethanol were obtained from Merck. Methanol and toluene were obtained from VWR. Aniline was obtained from Alfa Aesar.

Methods

Glass transition temperatures (Tg) were measured on a Q2000 DSC model from TA Instruments; values calculated from inflection points. Molecular weight determinations were carried out on a Shimadzu UFLC instrument fitted with Phenomenex Phenogel GPC columns for separation and having a UV and RI detection capability. The measurements were done in THF solvent containing 10 mM of LiBr at 40° C. and referenced to polystyrene standards. 1H NMR spectra were collected at NuMega Resonance Lab in San Diego, Calif.

Synthesis of Imino-Phenol, IP-VO

A 500 mL round bottom flask was charged with vanillin (15.2 g, 100 mmol) and treated with 100 mL of ethanol (EtOH). Once dissolved, ODA (10.0 g, 50.0 mmol) was added to the solution along with additional EtOH (80 mL). This was stirred for 2 h at room temperature, at which point nearly all ODA had dissolved to give a clear yellow solution. The reaction was set to reflux with rapid stirring in an oil bath for 4 h. Upon cooling to room temperature, a yellow product was filtered. The filtrate was further reduced in volume by half and added to 200 mL of deionized water to obtain more yellow product. The product was dried for 2 h at 110° C., followed by in vacuo overnight at 60° C. Yield 92%. Relevant 1H NMR data (d6-DMSO): δ 3.85 (s, 6H, OCH3), 8.48 (s, 2H, HC═N); 9.73 (br s, 2H, PhOH). Note: a 95:5 ratio of isomers noted. M.P. by DSC=164° C.

Synthesis of bis-imino-benzoxazine, IBZ-VO: Method One

A 100 mL round bottom flask was charged with IP-VO (3.00 g, 6.41 mmol) and PF (0.768 g, 25.6 mmol). Aniline (1.19 g, 12.8 mol) pre-dissolved in toluene (8.5 mL) was then added to the flask. The resulting mixture was set to reflux in an oil bath for 22 h to give a dark red solution. Upon cooling, a red sticky solid precipitated out of solution. The solution layer was decanted to isolate the solid, which was subsequently dissolved in dioxane and reprecipitated in MeOH. This sticky solid was dried in vacuo for 2 h at 40° C. to result in a red powder. Yield>30%. The imino-BZ structure was confirmed via NMR. Relevant 1H NMR data (d6-DMSO): CH3 peaks noted at 3.80 ppm; BZ ring CH2 peaks occur at 4.72 & 5.54 ppm; imine H noted at 8.44 ppm. All multiplets as a result of exchanged product species. DSC data (5° C./min, cycle 1 & 10° C./min cycle 2; N2): cure max=232° C.; Tg=180° C.

Synthesis of bis-imino-bezoxazine, IBZ-VO: Method Two

A 100 mL round bottom flask was charged with ODA (1.50 g, 7.50 mmol), vanillin (2.28 g, 15.0 mmol), aniline (1.40 g, 15.0 mmol), PF (0.900 g, 30.0 mmol) and 15 g of solvent (dioxane:EtOH; 2:1 w/w). The resulting mixture was set to reflux in an oil bath for 10 h to give an orange solution. Upon cooling, the solution was added to deionized water to precipitate an orange powder, which was filtered, washed once with water and then twice with hexanes. The resulting product was dried in vacuo overnight at 50° C. Yield>90%. The imino-BZ structure was confirmed via NMR. Relevant 1H NMR data (d6-DMSO): CH3 peaks noted at 3.80 ppm; BZ ring CH2 peaks occur at 4.72 & 5.55 ppm; imine H noted at 8.44 ppm. All multiplets as a result of mono- & bis-BZ products, as well as structural isomers. DSC data (5° C./min, cycle 1 & 10° C./min cycle 2; N2): cure max=232° C.; Tg=162° C.

Synthesis of polymeric imino-benzoxazine, IBZ-4B

A 100 mL round bottom flask was charged with BAPP (6.57 g, 16.0 mmol), 4HB (3.99 g, 32.7 mmol), PF (1.96 g, 65.3 mmol), and toluene (29.2 g). This mixture was set to reflux in an oil bath for 17 h to give a yellow-orange solution. An off-white gel (triazine network intermediate) was produced and subsequently dissolved within the first 10 min of reaction time.

The refluxed solution was allowed to cool to room temperature. This solution, which contains an aldehyde-benzoxazine species, was then treated with BAPP (6.83 g, 16.6 mmol) and EtOH (15.9 g). Stirring for 15 min at room temperature gave a clear golden yellow solution. The flask was then placed in an 80° C. oil bath and let stir for 2 hours, at which point it appeared hazy. Upon cooling, a viscous orange precipitate was produced. The entire solution mixture was added into rapidly-stirred MeOH to give a yellow powder. This powder was filtered, washed with additional MeOH, and dried in vacuo at 85° C. for 1.5 h. Yield>80%. Relevant ¹H NMR data (CDCl₃): 1.66 (m, 12H, CH3), 4.64 (s, 4H, NCH₂C), 5.39 (m, 4H, NCH₂O), 8.34 & 9.83 (m, 2H total, HC═N (76%) & HC═O (24%), respectively). GPC data (Mn/Mw): 6,090/10,200 Da. DSC data (5° C./min, cycle 1 & 10° C./min cycle 2; N₂): Pre-cure Tg=138° C.; cure max=251° C.; cured Tg=226° C.

Degradability Tests

The following tests were carried out to demonstrate thermoset matrix breakdown towards recycling purposes. Around 50 mg of resin was added to 10 mL of solvents to be tested within a glass vial. The vial was placed on a hot-plate or in an oil bath to reach a desired temperature and monitored towards depolymerization and dissolution in a given media. The degradation conditions for each resin are provided in Table 1 (r.t.=room temperature).

TABLE 1

| Cured Resin | Solvent | Condition(s) tested | Depolymerization |
|---|---|---|---|
| IBZ-VO | H₂O | a) 32° C., 6 h | No |
| | | b) r.t., overnight | |
| | H₂O/THF | a) 32° C., 6 h | No |
| | (1:4 v/v) | b) r.t., overnight | |
| | HCl(aq.)/THF | 32° C., 6 h | Yes. Dissolved |
| | 0.4M | | into solution. |
| IBZ-4B | H₂O | a) 50° C., 6 h | No |
| | | b) r.t., 3 days | |
| | THF | a) 50° C., 6 h | No |
| | | b) r.t., 3 days | |
| | HCl(aq.)/THF | 50° C., 6 h | Yes. Dissolved |
| | 0.4M | | into solution. |
| | HCl(aq.)/DMSO | 100° C., 6 h | Yes. Dissolved |
| | 0.4M | | into solution. |
| P-d | HCl(aq.)/THF | a) 32° C., 6 h | No |
| | 0.4M | b) r.t., overnight | |

As shown, the imino-BZ cured resins dissolved under various conditions in acidic media indicating depolymerization. In contrast, a commercially-available benzoxazine (P-d from Shikoku Chemicals) did not dissolve in acidic media.

Similarly, cured BZ resins bearing cleavable acetal groups, as depicted in FIG. 2, were noted to begin degradation (i.e., depolymerization) by agitation in acidic water (HCl·KCl buffer solution, 0.1 M, pH=2.0) within 48 hours, whereas commercial P-d did not exhibit degradation after 7 days under similar conditions.

Reprocessability Tests

A fully cured resin film of IBZ-VO (Tg=171° C.) was crushed into flakes. The flakes were piled together and hot-pressed at 215° C., 45 min, 17 MPa. The flakes reformed into a single new film by way of vitrimeric melt behavior. The process is shown in FIG. 4.

FIG. 4 shows an IBZ-VO monomer powder (top left) that is pressed into a cured film (top right). The initial hot pressing step is performed at 14 MPa and includes pressing at 170° C. for one hour, 185° C. for 3 hours and 220° C. for 30 minutes. The resultant cured film is relatively brittle due to its highly rigid structure. The cured film is then crushed into powdery flakes (bottom right) which are hot pressed into a new film. The second (reprocessing) hot pressing step is conducted at 17 MPa and 215° C. for 45 minutes. In this second pressing step, material flow is achieved via rapid network exchange, thus transforming the cured flakes into a whole film.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A degradable resin composition, comprising:
at least one benzoxazine group in a backbone or as an endcap; and
at least one cleavable covalent bond selected from the group consisting of an imine, an acetal, an ester, a disulfide, and combinations thereof.

2. The degradable resin composition of claim 1, wherein the at least one cleavable covalent bond is the imine.

3. The degradable composition of claim 1, wherein the at least one cleavable covalent bond is the acetal.

4. The degradable composition of claim 3, further comprising at least one acrylate group.

5. The degradable resin composition of claim 1, further comprising at least one cross-linkable group selected from the group consisting of acrylate, epoxy, nitrile, bismaleimide, citraconic imide, nadic imide, phenylethynyl, phenylethynyl imide, acrylic, methacrylic, cinnamic, allyl azide, and combinations thereof.

6. The degradable resin composition of claim 1, wherein the at least one benzoxazine group is a bis-benzoxazine.

7. The degradable resin composition of claim 1, wherein the degradable resin composition comprises the structure shown in Formula (IV): 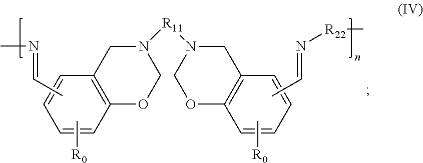
where R₁₁ and R₂₂ are independently an alkyl group, an aryl group, and alkylaryl group, a substituted alkyl group, a substituted aryl group, or a substituted alkylaryl group,
R₀ a hydrogen, alkyl, alkoxy, or hydroxy group, and n is an integer ranging from 1 to 100.

8. The resin composition of claim 7, wherein R₁₁ is derived from 2,2-Bis[4-(4-aminophenoxy) phenyl]propane.

9. The resin composition of claim 7, wherein R₀ is derived from 4-hydroxybenzaldehyde or 4-hydroxy-3-methoxybenzaldehyde.

10. The degradable resin composition of claim 1 further comprising fibers.

11. A thermoset composition, comprising:
a cured benzoxazine-based resin composition comprising the degradable composition of claim 1 in a cured state.

12. An article formed from the cured benzoxazine-based resin composition of claim 11.

13. A method of making a degradable resin composition, the method comprising:
reacting a first diamine with a phenolic aldehyde to produce an aldehyde-containing intermediate; and
reacting the aldehyde-containing intermediate with a second diamine to form the degradable resin composition.

14. The method of claim 13, wherein the first diamine and the second diamine are the same.

15. The method of claim 13, wherein the first diamine and the second diamine are different.

16. The method of claim 13, wherein the first diamine and the second diamine are independently selected from the group consisting of bis[4-(3-aminophenoxy)phenyl]sulfone, bis[4-(4-aminophenoxy)phenyl]sulfone, 1,4-diaminobenzene, 1,3-diaminobenzene, 2,4-diaminotoluene, 4,4′-diaminodiphenylmethane, 4,4′-diaminodiphenylether, 3,4′-diaminodiphenylether, 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,7-diamino-dimethyldibenzothiophen-5,5-dioxide, 4,4′-diaminobenzophenone, 3,3′-diaminobenzophenone, 4,4′-bis(4-aminophenyl) sulfide, 4,4′-diaminodiphenyl sulfone, 4,4′-diaminobenzanilide, 1,n-bis(4-aminophenoxy)alkane (n=3, 4 or 5), 1,3-bis(4-aminophenoxy)-2,2-dimethylpropane, 1,2-bis[2-(4-aminophenoxy)ethoxy]ethane, 1,5-bis(4-aminophenoxy) pentane, 1,3-bis(4-aminophenoxy) propane, 9,9-bis(4-aminophenyl)fluorene, 5(6)-amino-1-(4-aminomethyl)-1,3,3-trimethylindan, 1,4-bis(4-aminophenoxy)benzene, 1,3-bis(4-aminophenoxy)benzene, 1,3-bis(3-aminophenoxy)benzene, 4,4′-bis(4-aminophenoxy) biphenyl, 4,4′-bis(3-aminophenoxy)biphenyl, 2,2-Bis[4-(4-aminophenoxy) phenyl]propane, 2,2-bis[4-(4-aminophenoxy)phenyl]hexafluoropropane, 3,3′-dicarboxy-4,4′-diaminodiphenylmethane, 4,6-dihydroxy-1,3-phenylenediamine, 3,3′-dihydroxy-4,4′-diaminobiphenyl, 3,3′,4,4′-tetraminobiphenyl, 1,6-hexamethylenediamine, 1,8-octamethylenediamine, 1,9-nonamethylene diamine, 1,12-dodecamethylene diamine, 1-amino-3-aminomethyl-3,5,5-trimethylcyclohexane, 4,4′-dicyclohexylmethanediamine, cyclohexanediamine, and 1,3-bis(3-aminopropyl)-1,1,3,3-tetramethyldisiloxane.

17. The method of claim 14, wherein the first diamine and the second diamine are 2,2-Bis[4-(4-aminophenoxy) phenyl]propane.

18. The method of any of claim 13, wherein the phenolic aldehyde is 4-hydroxybenzaldehyde or 4-hydroxy-3-methoxybenzaldehyde.

19. The method of any of claim 13, further comprising, curing the degradable resin composition via an external stimulus selected from the group consisting of heat, ultraviolet irradiation, microwave irradiation, moisture, and combinations thereof.

20. A method of recycling a resin composition, comprising:
providing a cured polymer resin composite, the cured polymer resin composite comprising:
a cured benzoxazine-based resin composition including at least one cleavable covalent bond selected from the group consisting of an imine, an acetal, an ester, a disulfide, and combinations thereof; and
fibers;
exposing the cured polymer resin composite to an acid, thereby cleaving the at least one cleavable covalent bond to produce a degraded polymer resin; and
removing the fibers from the degraded polymer resin.
